(19) United States
(12) Patent Application Publication
(10) Pub. No.: US 2024/0141142 A1
(43) Pub. Date: May 2, 2024

(54) POLY(VINYL BUTYRAL) COMPOSITIONS FOR USE WITH SOLAR ADDITIVES

(71) Applicant: SOLUTIA INC., ST. LOUIS, MO (US)

(72) Inventor: BRUCE EDWARD WADE, WEST SPRINGFIELD, MA (US)

(73) Assignee: SOLUTIA INC., ST. LOUIS, MO (US)

(21) Appl. No.: 18/547,718

(22) PCT Filed: Feb. 25, 2022
(86) PCT No.: PCT/US2022/017822

§ 371 Date: Aug. 24, 2023

Related U.S. Application Data
(60) Provisional application No. 63/200,332, filed on Mar. 2, 2021.
(60) Provisional application No. 63/202,521, filed on Jun. 15, 2021.

(51) Int. Cl. C08K 13/02; B32B 17/10

(52) U.S. Cl. CPC C08K 13/02; B32B 17/10036; B32B 17/10605; B32B 17/10678; B32B 17/10688; B32B 17/10761; B32B 2307/748; C08K 2003/2282

(57) ABSTRACT

Provided are certain poly(vinyl acetal) compositions useful in safety glass construction. The compositions of the invention can be extruded into sheets and serve as interlayers between glass panels. In particular, the compositions comprise one or more solar additives and a divalent magnesium ion and at least 2 carboxylate groups wherein the corresponding carboxylic acids of the carboxylate groups each have a pKa of less than about 4.80. The respective magnesium salts used as adhesion control agents may be hydrates.

### FIELD OF THE INVENTION

The invention relates to the control of adhesion of polyvinyl butyral (PVB) sheet to glass in laminated safety glass structures.

### BACKGROUND OF THE INVENTION

Poly(vinyl butyral) (PVB) is commonly used in the manufacture of polymer sheets that can be used as interlayers in light-transmitting laminates such as safety glass or polymeric laminates. Safety glass typically refers to a transparent laminate comprising a poly(vinyl butyral) sheet disposed between two panes of glass. Safety glass often is used to provide a transparent barrier in architectural and automotive openings. Its main function is to absorb energy, such as that caused by a blow from an object, without allowing penetration through the opening. Additives to the sheet formulation generally include at least one adhesion control agent (hereinafter, “ACA”) to modify adhesion of the sheet to the glass so that a suitable level of adhesion can be maintained to prevent spalling of the glass while still providing adequate energy absorption if an impact occurs.

Safety glass can be formed by a process in which two layers of glass and a plastic interlayer, such as poly(vinyl butyral), are assembled into a pre-press, tacked into a pre-laminate, and finished into an optically clear laminate. The assembly phase can involve laying down a piece of glass, overlaying a poly(vinyl butyral) sheet on that glass, laying down a second piece of glass on the poly(vinyl butyral) sheet, and then trimming the excess poly(vinyl butyral) to the edges of the glass layers.

The plastic interlayer can be produced by mixing poly(vinyl butyral) polymer with one or more plasticizers, and optionally with one or more other ingredients, and melt processing the mix into sheeting, which typically is collected and rolled for storage and transportation.

The process of manufacturing poly(vinyl butyral) resin can entail the use of an acid to catalyze the formation of a vinyl acetal from vinyl alcohol and aldehyde precursors. After formation of the poly(vinyl acetal), the acids can be neutralized using an appropriate base. This process will typically leave residual acetate trapped within the poly(vinyl butyral) resin, which can impact both stabilization and adhesion qualities. The residual concentration of the acetate, however, can be a limiting factor when certain adhesion and other characteristics are desired in the finished poly(vinyl butyral).

Additionally, adhesion control agents in the sheet formulation control the adhesion of the sheet to the glass in order to provide energy absorption on impact of the glass laminate. In practice, this “control” equates to reducing the adhesion; thus, if the adhesion control agent(s) bind to the PVB or otherwise become immobile by reaction, the PVB adhesion to glass increases to an undesirable level. In particular, some adhesion control agents, when used in conjunction with various solar additives, for example magnesium 2-ethylbutyrate, a phenomenon called “binding” typically occurs in which the salt reacts with and binds to PVB during melt processing (e.g., extrusion) of the PVB formulation into the sheet. The bound salt is then unavailable for adhesion control which results in the sheet adhering too strongly to the glass in the finished laminate, resulting in low impact strength. Moreover, in general, the level of bound salt proportionally increases as the initial level of ACA or solar absorber in the formulation is increased. Accordingly, improved compositions and methods are needed to enhance the characteristics of poly(vinyl butyral) sheets, in particular those sheets which also contain solar additives.

### SUMMARY OF THE INVENTION

Poly(vinyl butyral) compositions used in safety glass constructions often contain solar additives, and other heat-shielding particles, in the form of metal oxide nanoparticles such as indium tin oxide, antimony tin oxide, cesium-doped tungsten oxide, and other doped tungsten oxides. Such nanoparticles are in one embodiment less than 200 nm (D₅₀), and in other embodiments less than 100 nm (D₅₀). In this regard, such nanoparticles will generally be less than about 200 nm or in some embodiments less than about 100 nm in diameter (D₅₀), with D₅₀ understood to be the volume-median-diameter as measured by dynamic light scattering, considered to be the average particle size by volume. When these solar additives are used in conjunction with certain adhesion control additives, such as multivalent metal salts of organic monocarboxylic acids (see, U.S. Pat. No. 5,728,472), for example magnesium 2-ethyl butyrate or 1-ethyl hexanoate, a phenomenon called “binding” occurs whereby the adhesion control agent becomes bound to the poly(vinyl butyral) resin and thus its effectiveness as an adhesion control agent is diminished. The present invention provides certain poly(vinyl butyral) compositions having at least one solar additive, which utilize a magnesium salt comprising a divalent magnesium ion and at least 2 carboxylate groups wherein the corresponding carboxylic acids of the carboxylate groups each have a pKa of less than about 4.80, such as magnesium salicylate or magnesium formate or their respective hydrates as the adhesion control agent (ACA). As used herein, when referring to magnesium salicylate or magnesium formate, the respective hydrates (magnesium salicylate tetrahydrate and magnesium formate dihydrate) are also included. These compositions were found to have significantly improved performance over existing poly(vinyl butyral) compositions comprising solar additives. As afforded by the present invention, poly(vinyl butyral) sheets of the invention exhibit improved stability in these metal oxide nanoparticle containing environments (e.g., indium tin oxide) in which the polymer sheet is exposed to high temperature and water content during extrusion, without unacceptably altering the adhesion qualities of the polymer sheet due to significant degradation of the magnesium ACA salt (i.e., magnesium 2-ethyl butyrate or 2-ethyl hexanoate) during extrusion. Combinations of differing levels of magnesium ACA salt titer and alkali metal ACA salt titer can be used to adjust and control adhesion, as exhibited by both peel and pummel test methods. Accordingly, the invention makes possible the extrusion of poly(vinyl butyral) with solar metal oxide nanoparticles without having to limit residual moisture in the poly(vinyl butyral) resin and water from other additives in the extruder formulation. Post extrusion heat treatment of extruded sheet, including the re-moisturization of the PVB sheet and the lamination process, are also protected.

In an embodiment, a polymer interlayer for glazing comprises: poly (vinyl butyral), at least one plasticizer, a solar additive, sodium and/or potassium acetate, and a magnesium salt comprising a divalent magnesium ion and at least 2 carboxylate groups wherein the corresponding carboxylic acids of the carboxylate groups each have a pKa of less than about 4.80 (4.70, 4.60, 4.50, 4.40, 4.30, 4.20, 4.10, 4.00).

In embodiments, the polymer interlayer comprises at least two magnesium salts comprising a divalent magnesium ion and at least 2 carboxylate groups wherein the corresponding carboxylic acids of the carboxylate groups each have a pKa of less than about 4.80 (4.70, 4.60, 4.50, 4.40, 4.30, 4.20, 4.10, 4.00).

In embodiments, the magnesium salt is magnesium salicylate, magnesium formate, magnesium salicylate tetrahydrate or magnesium formate dihydrate.

In embodiments, the level of binding (% binding) is less than 25% (24, 23, 22, 21, 20, 19, 18, 17, 16, 15, 14, 13, 12, 11 or less than 10%).

In embodiments, the plasticizer comprises a plasticizer having a refractive index of at least 1.460, measured by ASTM D542 at a wavelength of 589 nm and a temperature of 25° C. In other embodiments, the plasticizer comprises a blend of plasticizers. In embodiments, the plasticizer comprises a blend of a conventional plasticizer (having a refractive index of less than 1.460, measured by ASTM D542 at a wavelength of 589 nm and a temperature of 25° C.) and a plasticizer having a refractive index of at least 1.460, measured by ASTM D542 at a wavelength of 589 nm and a temperature of 25° C.

In embodiments, an interlayer sheet comprises the composition previously described, wherein the composition is formed into the interlayer sheet. In embodiments, the interlayer sheet further comprises one or more additional layers to form a multi-layer sheet, and in some embodiments, the interlayer sheet comprises three layers.

In embodiments, a laminated safety glass comprises two sheets of glass and the interlayer sheet previously described, wherein the interlayer sheet is disposed between the two glass sheets. In embodiments of the laminated safety glass, at least one of the two glass sheets of the laminated safety glass further comprises a metal coating. In other embodiments, the laminated safety glass further comprises a thermoplastic film adjacent the interlayer sheet, and in embodiments, the thermoplastic film comprises a polyester.

### DETAILED DESCRIPTION OF THE INVENTION

In a first aspect, the invention provides a polymer composition comprising:
a. poly(vinyl acetal);
b. a solar additive;
c. sodium and/or potassium acetate;
d. at least one plasticizer; and
e. a magnesium salt comprising a divalent magnesium ion and at least 2 carboxylate groups wherein the corresponding carboxylic acids of the carboxylate groups each have a pKa of less than about 4.80 (4.70, 4.60, 4.50, 4.40, 4.30, 4.20, 4.10, 4.00), wherein the titer of magnesium salt or hydrate thereof is from about 10 to about 60, wherein the alkalinity titer attributable to the combination of potassium and sodium acetate is from about 10 to about 60, and wherein the ratio of the titer of magnesium salt or hydrate thereof to the alkalinity titer attributable to the combination of potassium and sodium acetate is about 0.5 to about 2.0.

In a second aspect, the invention provides a polymer composition comprising:
a. poly(vinyl acetal) wherein the resin has moisture level of less than about 1 wt. %;
b. a solar additive;
c. sodium and/or potassium acetate;
d. at least one plasticizer; and
e. a magnesium salt comprising a divalent magnesium ion and at least 2 carboxylate groups wherein the corresponding carboxylic acids of the carboxylate groups each have a pKa of less than about 4.80 (4.70, 4.60, 4.50, 4.40, 4.30, 4.20, 4.10, 4.00), wherein the titer of magnesium salt or hydrate thereof is from about 10 to about 60, wherein the alkalinity titer attributable to the combination of potassium and sodium acetate is from about 10 to about 60, and wherein the ratio of the titer of magnesium salt or hydrate thereof to the alkalinity titer attributable to the combination of potassium and sodium acetate is about 0.5 to about 2.0.

Poly(vinyl acetal) resins as referred to in component a) above can be formed by acetalization of poly(vinyl alcohol) with one or more aldehydes in the presence of an acid catalyst. The resulting resin can then be separated, stabilized, and dried according to known methods such as, for example, those described in U.S. Pat. Nos. 2,282,057 and 2,282,026, as well as Wade, B. (2016), “Vinyl Acetal Polymers”, Encyclopedia of Polymer Science and Technology, pp. 1-22 (John Wiley & Sons, Inc.). The total amount of residual aldehyde groups, or residues, present in the resulting poly(vinyl acetal) resin can be at least about 50, at least about 60, at least about 70, at least about 75, at least about 80, or at least about 85 weight percent, as measured by ASTM D-1396. The total amount of aldehyde residues in a poly(vinyl acetal) resin can be collectively referred to as the acetal component, with the balance of the poly(vinyl acetal) resin comprising residual hydroxyl and residual acetate groups, which will be discussed in further detail below.

In some embodiments, the vinyl acetal component of a poly(vinyl n-butyral) resin can include primarily vinyl butyral from n-butyraldehyde and may, for example, comprise at least about 70, at least about 80, or at least about 90 weight percent of vinyl butyral from n-butyraldehyde.

One or more poly(vinyl acetal) resins may also include one or more vinyl acetals from one or more aldehydes, other than n-butyraldehyde. For example, in some embodiments, at least one poly(vinyl acetal) resin in the composition, layer, or interlayer may be derived from at least one other C₂ to C₈ aldehyde, including, for example, acetaldehyde, propionaldehyde, iso-butyraldehyde, 2-methylvaleraldehyde, n-hexyl aldehyde, 2-ethylhexyl aldehyde, n-octyl aldehyde, and combinations thereof. In some embodiments, at least one poly(vinyl acetal) resin may be derived from one or more C₄ to C₈ aldehydes selected from the group consisting of iso-butyraldehyde, 2-ethylhexyl aldehyde, and combinations thereof. In various embodiments, at least one poly(vinyl acetal) resin can include zero weight percent, or can include at least about 1, at least about 5, at least about 10, at least about 20, at least about 30, at least about 40 and/or not more than about 80, not more than about 70, not more than about 60, not more than about 50, not more than about 40 weight percent, or about 0 to about 40, about 0 to about 30, about 0 to about 20, about 1 to about 80, about 5 to about 70, or about 10 to about 60 weight percent of one or more aldehydes other than n-butyraldehyde.

The poly(vinyl butyral) can be produced by known acetalization processes that involve reacting poly(vinyl alcohol) with butyraldehyde in the presence of an acid catalyst, followed by steps including neutralization, separation, washing, and drying of the resin. Some separation and washing may be done before neutralization to reduce the amount of acid to be neutralized, for example in an aqueous process after acetalization.

Two methods that have been employed are the solvent process and the aqueous process (see, for example, Wade, B. (2016), “Vinyl Acetal Polymers”, Encyclopedia of Polymer Science and Technology, pp. 1-22 (John Wiley & Sons, Inc.). In either method, poly(vinyl alcohol) is reacted with an aldehyde in the presence of mineral or organic acid catalysts to produce a poly(vinyl acetal) and water. If butyraldehyde is used as the aldehyde, then the resulting acetal is poly(vinyl butyral).

In embodiments, the poly(vinyl acetal) resin has a moisture level of less than about 1 wt. %.

Any suitable strong acid (or mineral acid) may be utilized and will generally include acetic acid which may be produced in-situ in the hydrolysis of polyvinyl acetate. In certain embodiments, sulfuric acid is utilized as the primary acid catalyst.

After acetal formation in either of the above methods, neutralization of the residual acids can be accomplished by, for example, the addition of a hydroxide compound; in the case of potassium hydroxide, this results in potassium acetate, which then functions as an adhesion control agent. As disclosed in U.S. Pat. Nos. 5,728,472 and 3,271,235, for example, either sodium hydroxide or potassium hydroxide may be used to neutralize the acids. The use of either of these hydroxides can result in a residual titer of the corresponding acetate salt(s) within the polymer matrix (see, for example, U.S. Pat. No. 2,496,480). This residual titer is generally desirable because it prevents the degradation of the finished polymer because of the detrimental action of residual oxides of sulfur (if sulfuric acid is used as the primary acid catalyst, for example).

This adhesiveness or adhesion level of the finished polymer sheet is further improved in the case of the present invention by the use of the adhesion control agent, a divalent magnesium ion and at least 2 carboxylate groups wherein the corresponding carboxylic acids of the carboxylate groups each have a pKa of less than about 4.80, such as a magnesium salicylate or magnesium formate or the corresponding hydrates thereof.

In various embodiments, the polymer comprising poly(vinyl butyral) comprises about 9 to about 35 weight percent (wt. %) hydroxyl groups calculated as PVOH, 13 to 30 wt. % hydroxyl groups calculated as PVOH, or 15 to 22 wt. % hydroxyl groups calculated as PVOH. The polymer sheet can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, for example butyraldehyde acetal, but optionally including other acetal groups in a minor amount, e.g., a 2-ethyl hexanal group (see, for example, U.S. Pat. No. 5,137,954) or vinyl ethanal from acetaldehyde.

In various embodiments, the polymer comprises poly(vinyl butyral) having a molecular weight greater than 30,000, 40,000, 50,000, 55,000, 60,000, 65,000, 70,000, 120,000, 250,000, or greater than 350,000 grams per mole (g/mole or Daltons). Small quantities of a dialdehyde or trialdehyde can also be added during the acetalization step to increase molecular weight to greater than 350,000 g/m (see, for example, U.S. Pat. Nos. 4,902,464; 4,874,814; 4,814,529; 4,654,179). As used herein, the term “molecular weight” means the weight average molecular weight. Any suitable method can be used to produce the polymer sheets of the present invention.

The solar additives can be chosen from metal oxide nanoparticles such as antimony tin oxide, indium tin oxide, cesium-doped tungsten oxide, and other doped tungsten oxides. In this regard, such doped tungsten oxides may be described by the general formula W_{y}O_{z}, where W is tungsten, O is oxygen, satisfying 2.0<z/y<3.0, 2.2≤z/y≤2.99, or 2.45≤z/y≤2.99, and/or particles of composite tungsten oxide expressed by the general formula MₓW_{y}O_{z} where M is an element selected from H, He, alkali metals, alkaline-earth metals, rare-earth metals, Mg, Zr, Cr, Mn, Fe, Rh, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, and combinations of two or more thereof, wherein W is tungsten, O is oxygen, satisfying 0.001≤x/y≤1.0 or 0.01≤x/y≤0.5, and 2.0≤z/y≤3.0, 2.2≤z/y ≤2.99, or 2.45≤z/y≤2.99. Examples of tungsten/oxygen ratios include, without limitation, WO_{2.92}, WO_{2.90}, WO₂₀O₅₈, W₂₄O₆₈, W₁₇O₄₇, W₁₈O₄₉, and the like. In certain embodiments, the tungsten oxide agent is cesium tungsten oxide (CsWO₃) having any of the above-described characteristics, and, in various embodiments, a cesium tungsten oxide agent having the mole ratio Cs_{0.33}WO₃ is used. See, for example, U.S. Pat. No. 8,216,683, incorporated herein by reference. In certain embodiments, the infrared absorbing particles can comprise indium tin oxide, cesium-doped tungsten oxide, and combinations thereof.

In various embodiments, the polymer compositions of the present invention can comprise 20 to 80, 20 to 60, 25 to 60, or 35 to 45 parts of plasticizer per one hundred parts of resin (phr). Of course, other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) sheet. In general, higher amounts of plasticizer are added to decrease the T_{g}. Poly(vinyl butyral) polymer sheets of the present invention can have a T_{g} of 40° C. or less, 35° C. or less, 30° C. or less, 25° C. or less, 20° C. or less, or 15° C. or less.

Examples of suitable plasticizers can include, but are not limited to, conventional plasticizers such as triethylene glycol di-(2-ethylhexanoate) (“TEG-EH”, also known as “3GEH”), triethylene glycol di-(2-ethylbutyrate), triethylene glycol diheptanoate, tetraethylene glycol diheptanoate, tetraethylene glycol di-(2-ethylhexanoate) (“4GEH”), dihexyl adipate, dioctyl adipate, hexyl cyclohexyladipate, diisononyl adipate, heptylnonyl adipate, di(butoxyethyl) adipate, and bis(2-(2-butoxyethoxy)ethyl) adipate, dibutyl sebacate, dioctyl sebacate, and mixtures thereof. The plasticizer may be selected from the group consisting of triethylene glycol di-(2-ethylhexanoate) and tetraethylene glycol di-(2-ethylhexanoate), or the plasticizer can comprise triethylene glycol di-(2-ethylhexanoate). As used herein, plasticizer having a refractive index of about 1.450 or less is referred to as a “conventional plasticizer”. These plasticizers have refractive indices of about 1.442 to about 1.449. In comparison, PVB resin has a refractive index of approximately 1.485 to 1.495. In interlayers manufactured for various properties and applications, TEG-EH (refractive index=1.442) is one of the most common plasticizers present. Other plasticizers, including those not listed herein, may also be used.

In some embodiments, the plasticizer included in one or more layers may be a high refractive index (RI) plasticizer. As used herein, the term “high RI plasticizer” means a plasticizer having a refractive index of at least 1.460, measured by ASTM D542 at a wavelength of 589 nm and a temperature of 25° C. When used, the high RI plasticizer can have a refractive index of at least about 1.470, at least about 1.480, at least about 1.490, at least about 1.500, at least about 1.510, at least about 1.520 and/or not more than about 1.600, not more than about 1.575, or not more than about 1.550, measured as discussed above.

Examples of types or classes of high RI plasticizers can include, but are not limited to, polyadipates (RI of about 1.460 to about 1.485); epoxides such as epoxidized soybean oils (RI of about 1.460 to about 1.480); phthalates and terephthalates (RI of about 1.480 to about 1.540); benzoates and toluates (RI of about 1.480 to about 1.550); and other specialty plasticizers (RI of about 1.490 to about 1.520). Specific examples of suitable RI plasticizers can include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), di-(butoxyethyl) terephthalate, di-(butoxyethyoxyethyl) terephthalate, and mixtures thereof. The high RI plasticizer may be selected from dipropylene glycol dibenzoate and tripropylene glycol dibenzoate, and/or 2,2,4-trimethyl-1,3-pentanediol dibenzoate.

When the resin layer or interlayer includes a high RI plasticizer, the plasticizer can be present in the layer alone or it can be blended with one or more additional plasticizers. The other plasticizer or plasticizers may also comprise high RI plasticizers, or one or more may be a lower RI plasticizer having a refractive index of less than 1.460. In some embodiments, the lower RI plasticizer may have a refractive index of less than about 1.450, less than about 1.445, or less than about 1.442 and can be selected from the group listed previously. When a mixture of two or more plasticizers are employed, the mixture can have a refractive index within one or more of the above ranges.

In some embodiments, the interlayer may include at least a first resin layer comprising a first resin and a first plasticizer and a second resin layer comprising a second resin and a second plasticizer. The first and second plasticizer can be the same type of plasticizer, or the first and second plasticizers may be different. In some embodiments, at least one of the first and second plasticizers may also be a blend of two or more plasticizers, which can be the same as or different than one or more other plasticizers.

In various embodiments, the high refractive index plasticizer(s) is selected such that the refractive index of the plasticizer is at least about 1.460, or greater than about 1.460, or greater than about 1.470, or greater than about 1.480, or greater than about 1.490, or greater than about 1.500, or greater than 1.510, or greater than 1.520, for both the core and/or skin layers. In some embodiments, the high refractive index plasticizer(s) is used in conjunction with a conventional plasticizer, and in some embodiments, if included, the conventional plasticizer is triethylene glycol di-(2-ethylhexanoate) (TEG-EH), and the refractive index of the plasticizer mixture is at least 1.460. As used herein, the refractive index of a plasticizer or a resin used in the entirety of this disclosure is either measured in accordance with ASTM D542 at a wavelength of 589 nm and 25° C. or as reported in literature in accordance with ASTM D542.

The magnesium salicylate [CAS No. 18917-89-0] or a tetrahydrate thereof [CAS No. 18917-95-8] can be prepared as a 20 percent by weight aqueous solution at room temperature, for addition to a poly(vinyl butyral) resin-plasticizer premix for extrusion. The aqueous solution is only weakly acidic and was not found to de-acetalize the poly(vinyl butyral) resin at the level of addition during standard extrusion conditions. Similarly, this aqueous solution can contain additional sodium acetate and/or potassium acetate as desired. Magnesium formate [CAS No. 557-39-1] or a dihydrate thereof [CAS No. 6150-82-9] can be prepared as a 10 percent by weight aqueous solution at room temperature and can be added in a similar preparation based on the magnesium salt titer required.

In a further embodiment, the polymer composition may further comprise, as solar additive stabilizers, one or more epoxy compounds. These epoxy compounds may be added to the polymer composition itself, or the epoxy compounds may be added to a film covering at least a portion of the polymer sheet, which also contains one or more solar additives. Any suitable epoxy compound can be used with the present invention, as are known in the art (see, for example, U.S. Pat. Nos. 5,529,848 and 5,529,849, incorporated herein by reference).

In various embodiments, epoxy compounds useful as described herein are selected from (a) epoxy resins comprising mainly the monomeric diglycidyl ether of bisphenol-A; (b) epoxy resins comprising mainly the monomeric diglycidyl ether of bisphenol-F; (c) epoxy resins comprising mainly the hydrogenated diglycidyl ether of bisphenol-A; (d) polyepoxidized phenol novolacs; (e) diepoxides of polyglycols, alternatively known as an epoxy terminated polyether; and (f) a mixture of any of the foregoing epoxy resins of (a) through (e) (see the Encyclopedia of Polymer Science and Technology, Volume 6, 1967, Interscience Publishers, N.Y., pages 209-271).

A suitable commercially available diglycidyl ether of bisphenol-A of class (a) is D.E.R.™ 331 from Dow Chemical Company or Olin Corporation. A diglycidyl ether of bisphenol-F epoxy of class (b) is EPON Resin DPL-862 (Hexion) and a hydrogenated diglycidyl ether of bisphenol-A epoxy of class (c) is EPONEX™ Resin 1510 (Hexion). A polyepoxidized phenol formaldehyde novolac of class (d) is available from Olin Corporation as D.E.N™ 431. A diepoxide of poly(oxypropylene) glycol of class (e) is available from Olin Corporation as D.E.R.™ 732.

Further examples of suitable epoxy compounds include 3,4-epoxycyclohexane carboxylate compositions of the type described in U.S. Pat. No. 3,723,320. An example of suitable epoxy compounds correspond to the formula:

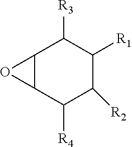

wherein R₁ is —(CH₂)₀₋₃—C(O) OR, —C(O) R, —OR, or —CH₂OR where R is an alkyl radical having from 1 to about 12 carbon atoms, R is R₁, hydrogen, or an alkyl radical having from 1 to about 9 carbon atoms, and R₃ and R₄ are individually hydrogen or an alkyl radical having from 1 to about 4 carbon atoms.

Also useful are diepoxides such as those disclosed in U.S. Pat. No. 4,206,067 that contain two linked cyclohexane groups to each of which is fused an epoxide group. Such diepoxide compounds correspond to the formula:

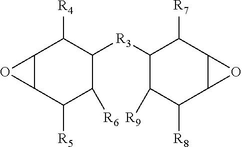

wherein R₃ is an organic group containing 1 to 10 carbon atoms, from 0 to 6 oxygen atoms, and from 0 to 6 nitrogen atoms, and R₄ through R₉ are independently selected from among hydrogen and aliphatic groups containing 1 to 5 carbon atoms. Exemplary diepoxides include 3,4-epoxycyclohexylmethyl-3,4-epoxycyclohexane, bis (3,4-epoxy-6-methylcyclohexylmethyl adipate), and 2-(3,4-epoxycyclohexyl)-5,5-spiro(3,4-epoxy)cyclohexane-m-dioxane. Further examples can be found in U.S. Pat. No. 7,585,436, incorporated herein by reference.

A further useful epoxy is 2-ethylhexyl glycidyl ether (available from Hexion as Heloxy Modifier 116). Further useful epoxies include diepoxides of poly(oxypropylene) glycol, 2-ethylhexyl glycidyl ether, and diepoxide products of epichlorohydrin and polypropylene glycol. Mixtures of epoxy compounds can also be used.

Epoxy compounds can be incorporated in any suitable amount, with the type of epoxy agent or agents, the composition of the polymer film, and the amount of solar additive factoring into the determination. Epoxy compounds will generally be incorporated along with the solar additive, for example within a film, it may be deposited on a film, within a hardcoat of a film, in a binder that binds two polymer films together into a multiple layer film, or otherwise injected alone or in conjunction with other additives as the film is being manufactured.

In various embodiments, epoxy compounds are incorporated at a weight percent of 0.2 to 10.0, 0.3 to 5.0, 0.5 to 4.0, or 1.0 to 3.5 weight percent of a polymer film. These values can be combined with the values given above for solar additives in any combination, as is desired for any particular application.

In another embodiment, the composition may further comprise one or more silicon-containing silane compounds, such as alkoxy silanes, as adhesion control stabilizing compounds. One example of such a compound is a silanol compound. When the adhesion control stabilizing agent present on the surface of the sheet comprises a silanol, the coating material applied to the surface of the polymer sheet may include the silanol, or it may include one or more unhydrolyzed silicon-containing compounds that can be converted to silanol upon application of the coating material to the sheet. Examples of suitable silicon-containing compounds that are readily convertible into silanol containing compounds can include organic alkoxysilanes including monoalkoxysilanes, dialkoxysilanes, and trialkoxysilanes. In some embodiments, the silicon-containing compound may be a trialkoxysilane such as, for example, a trimethoxysilane or a triethoxysilane. Examples of suitable trialkoxysilanes can include, but are not limited to, γ-glycidoxypropyltrimethoxysilane, aminopropyltriethyoxysilane, aminoethylaminopropyltrimethoxysilane, and combinations thereof. When the silicon-containing compound comprises a silanol, it may comprise the hydrolyzed form of one or more of the silicon-containing compounds listed above. Examples of such silanes include γ-glycidoxypropyltrimethoxysilane, aminoethylaminopropyltrimethoxysilane, and combinations thereof. Further examples may be found in U.S. Pat. No. 10,022,908, incorporated herein by reference.

Other additives may be incorporated into the polymer composition to enhance its performance in a final product. Such additives include, but are not limited to dispersants, plasticizers, dyes, pigments (e.g., rutile titanium dioxide), stabilizers (e.g., ultraviolet stabilizers), antioxidants, flame retardants, other infrared absorbers, combinations of the foregoing additives, and the like, as are known in the art.

Accordingly, the poly(vinyl acetal) polymer compositions can be thermally processed and configured into sheet form according to methods known to those of ordinary skill in the art. Thus, in another aspect, the polymer compositions of the invention are formed into a sheet.

The terms “polymer interlayer sheet,” “interlayer,” and “polymer melt sheet” as used herein, generally may designate a single-layer sheet or a multilayered interlayer. A “single-layer sheet,” as the name implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of a single-layer sheet and a plural-layer sheet; and a combination of at least one plural-layer sheet and at least one co-extruded sheet. In various embodiments of the present disclosure, a multilayered interlayer comprises at least two polymer layers (e.g., a single layer or multiple layers co-extruded and/or laminated together) disposed in direct contact with each other, wherein each layer comprises a polymer resin, as detailed more fully below. As used herein for multilayer interlayers having at least three layers, “skin layer” generally refers to the outer layers of the interlayer and “core layer” generally refers to the inner layer(s). Thus, one exemplary embodiment would be: skin layer//core layer//skin layer. A layer or combination of layers may comprise a solar additive. Further details regarding multiple-layer sheets can be found in U.S. Pat. No. 10,252,500, incorporated herein by reference.

In a further aspect, the invention provides the sheet of the invention which is a multilayered sheet.

One exemplary method of forming a poly(vinyl butyral) sheet comprises extruding molten poly(vinyl butyral) comprising resin, plasticizer, and additives (hereinafter “melt”) by forcing the melt through a sheet die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet. In either embodiment, the surface texture at either or both sides of the sheet may be controlled by adjusting the surfaces of the die opening or by providing texture at the roller surface. Other techniques for controlling the sheet texture include varying parameters of the materials (for example, the water content of the resin and/or the plasticizer, the melt temperature, molecular weight distribution of the poly(vinyl butyral), or combinations of the foregoing parameters). Furthermore, the sheet can be configured to include spaced projections that define a temporary surface irregularity to facilitate the de-airing of the sheet during lamination processes after which the elevated temperatures and pressures of the laminating process cause the projections to melt into the sheet, thereby resulting in a smooth finish. In various embodiments, the polymer sheets can have thicknesses of 0.1 to 2.5 millimeters, 0.2 to 2.0 millimeters, 0.25 to 1.75 millimeters, and 0.3 to 1.5 millimeters (mm).

Accordingly, in another embodiment, the invention provides the poly(vinyl acetal) compositions of the invention formed into a sheet.

Also included in the present invention are stacks or rolls of any of the polymer composition sheets of the present invention disclosed herein in any combination.

Also included in the present invention are methods of making windshields and other laminated glass products, comprising the steps of inserting a polymer sheet of the present invention between two layers of glass and laminating the three-layer stack.

Further, the present invention includes a laminated safety glass comprising a layer of glass, typically comprising silicon dioxide (although other types of glass as described below may be used), disposed in contact with any of the polymer sheets of the present invention. Further included is a laminated safety glass comprising at least two sheets of glass with an interlayer polymer sheet disposed between said glass sheets, wherein the polymer sheet is any of the polymer sheets disclosed herein as embodiments of the present invention.

Multiple layer glazings or panels as described herein generally comprise a first rigid substrate sheet having a first substrate thickness and a second rigid substrate sheet having a second substrate thickness. Each of the first and second substrates can be formed of a rigid material, such as glass, and may be formed from the same, or from different, materials. In some embodiments, at least one of the first and second substrates can be a glass substrate, while, in other embodiments, at least one of the first and second can be formed of another material including, for example, a rigid polymer such as polycarbonate, copolyesters, acrylic, polyethylene terephthalate, and combinations thereof. In embodiments, both rigid substrates are glass. Any suitable type of non-glass material may be used to form such a substrate, depending on the required performance and properties. Typically, none of the rigid substrates are formed from softer polymeric materials, including thermoplastic polymer materials as described in detail below.

Any suitable type of glass may be used to form the rigid glass substrate, and, in some embodiments, the glass may be selected from the group consisting of alumina-silicate glass, borosilicate glass, quartz or fused silica glass, and soda lime glass. The glass substrate, when used, may be annealed, thermally-strengthened or tempered, chemically-tempered, etched, coated, or strengthened by ion exchange, or it may have been subjected to one or more of these treatments. The glass itself may be rolled glass, float glass, or plate glass. In some embodiments, the glass may not be chemically-treated or strengthened by ion exchange, while, in other embodiments, the glass may not be an alumina-silicate glass. When the first and second substrates are glass substrates, the type of glass used to form each substrate may be the same or different.

The rigid substrates can have any suitable thickness. In some embodiments, when the rigid substrates are all glass substrates, the nominal thickness of at least one of the glass sheets (first or second glass) ranges from 0.1 mm to 12.7 mm and the multiple layer glass panels include the configurations of any combinations of the first and second glass sheets (and any other glass or rigid sheets, if desired). In some embodiments, the nominal thickness of the first and/or second substrates can be at least about 0.4, at least about 0.5, at least about 0.7, at least about 0.75, at least about 1.0, at least about 1.25, at least about 1.3, at least about 1.6, at least about 1.9, at least about 2.2, at least about 2.5, or at least about 2.8 and/or less than about 3.2, less than about 2.9, less than about 2.6, less than about 2.5, less than about 2.3, less than about 2.0, less than about 1.75, less than about 1.7, less than about 1.5, less than about 1.4, or less than about 1.1 mm.

Additionally, or in the alternative, the first and/or second substrates can have a nominal thickness of at least about 2.3, at least about 2.6, at least about 2.9, at least about 3.2, at least about 3.5, at least about 3.8, or at least about 4.1 and/or less than about 12.7, less than about 12.0, less than about 11.5, less than about 10.5, less than about 10.0, less than about 9.5, less than about 9.0, less than about 8.5, less than about 8.0, less than about 7.5, less than about 7.0, less than about 6.5, less than about 6.0, less than about 5.5, less than about 5.0, or less than about 4.5 mm. Other thicknesses may be appropriate depending on the application and properties required.

The present invention also includes windshields, windows, and other finished glass products or multiple layer panels comprising a polymer sheet of the present invention.

Various polymer sheet and/or laminated glass characteristics and measuring techniques will now be described for use with the present invention. The clarity of a polymer sheet, and particularly a poly(vinyl butyral) sheet, can be determined by measuring the haze level or value, which is a quantification of light not transmitted through the sheet. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, or less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) sheet is then removed, and the amount of glass left adhered to the poly(vinyl butyral) sheet is visually compared with a set of standards. The standards correspond to a scale in which varying degrees of glass remain adhered to the poly(vinyl butyral) sheet. In particular, at a pummel standard of zero, no glass is left adhered to the poly(vinyl butyral) sheet. At a pummel standard of 10, 100% of the glass remains adhered to the poly(vinyl butyral) sheet. For laminated glass panels of the present invention, various embodiments have a pummel of at least 3, at least 5, at least 8, at least 9, or 10. Other embodiments have a pummel between 8 and 10, inclusive.

The sheets and layers described herein may be capable of maintaining adhesion to other layers or substrates despite high levels of moisture ingress, even when the laminate is exposed to conditions of elevated temperature and humidity. For example, the layers and interlayers according to the invention may exhibit a peel adhesion while having an average moisture content of at least about 0.3, at least about 0.4, at least about 0.5, at least about 0.7, or at least 1 percent, as measured by Karl-Fischer Titration according to ASTM E203.

The “yellowness index” of a polymer sheet can be measured according to the following: Transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness.

As used herein, “titer” can be determined for sodium acetate and potassium acetate (as used herein, the “total alkaline titer”) and magnesium salts in a sheet sample using the following method.

In order to determine the amount of resin in each sheet sample that is weighed, the following equation is used, where PHR is defined as the pounds per hundred pounds of resin including plasticizer and any other additives to the resin in the original sheet sample preparation.

$$Grams of resin in sheet sample = \frac{Grams of sheet sample}{( 100 + PHR ) / 100}$$

Approximately 5 grams (g) of resin in the sheet sample is the target mass used to estimate the amount of sheet sample to start with, with the calculated mass of resin in the sheet sample used for each titer determination. All titrations should be completed in the same day.

The sheet sample is dissolved into 250 ml of methanol in a beaker. It may take up to 8 hours for the sheet sample to be completely dissolved. A blank with just methanol is also prepared in a beaker. The sample and blank are each titrated with 0.00500 normal HCl using an automated pH titrator programmed to stop at a pH of 2.5. The amount of HCl added to each the sample and the blank to obtain a pH of 4.2 is recorded. The HCl titer is determined according to the following equation.

$$HCl Titer ( ml 0.01 N HCL / 100 g resin ) = \frac{50 \times ( ml of HCl for sample - ml of HCl for blank )}{Calculated grams of resin}$$

To determine magnesium salt titer, the following procedure is used: 12 to 15 ml of pH 10.00 Buffer solution, prepared from 54 grams of ammonium chloride and 350 ml of ammonium hydroxide diluted to one liter with methanol, and 12 to 15 ml of Erichrome Black T indicator are added to the blank and each sheet sample, all of which have already been titrated with HCl, as described above. The titrant is then changed to a 0.000298 g/ml EDTA solution prepared from 0.3263 g tetrasodium ethylenediaminetetraacetate dihydrate, 5 ml water, diluted to one liter with methanol. The EDTA titration is measured by light transmittance at 596 nm. The % transmittance is first adjusted to 100% in the sample or blank before the titration is started while the solution is a bright magenta-pink color. When transmittance at 596 nm becomes constant, the EDTA titration is complete, and the solution will be a deep indigo color. The volume of EDTA titrated to achieve the indigo blue end point is recorded for the blank and each sheet sample. Magnesium salt titer is determined according to the following equation.

$$Magnesium Salt Titer ( as 1 \times {10}^{- 7} mole of Magnesium salt per gram resin ) = \frac{0.000298 g / ml EDTA \times ( ml of EDTA for sample - ml of EDTA for blank )}{( grams of resin in sheet sample ) \times 380.2 g / mole EDTA \times 1. \times {10}^{- 7}}$$

From this result, total alkaline titer, as 1×10⁻⁷ mole of acetate salt per gram resin, can be calculated according to the following equation.

Total Alkaline Titer=HCl titer of sheet−(2 ×Total Magnesium Salt Titer)

The portion of the total alkalinity titer attributable to either sodium acetate or potassium acetate can be determined by first determining the total alkaline titer, as described above. After determining total alkaline titer, destructive analysis on the polymer sheet can be performed by Inductively Coupled Plasma Emission Spectroscopy (ICP) resulting in a ppm concentration for potassium and a ppm concentration for sodium.

The alkaline titer attributable to sodium acetate is defined herein as the total alkaline titer multiplied by the ratio [ppm sodium/(ppm sodium+ppm potassium)].

The alkaline titer attributable to potassium acetate is defined herein as the total alkaline titer multiplied by the ratio [ppm potassium/(ppm sodium+ppm potassium)].

This invention can be further illustrated by the following examples of certain embodiments thereof, although it will be understood that these examples are included merely for purposes of illustration and are not intended to limit the scope of the invention unless otherwise specifically indicated.

### EXAMPLES

Two premix batches with resin and plasticizer mixes based on 1500 grams PVB resins for each case were used for sheet extrusion at about 200° C. Samples of the PVB sheet were only collected towards the end of extrusion (about 5 minutes) before the second premix batch was used up in extrusion for each case tested by ACA titration to ensure steady state composition.

Example titrations were performed on samples with and without ITO nanoparticles to show low binding compared to high binding. Samples 1, 2 and 6 contained no ITO nanoparticles, and Samples 3, 4 and 5 all contained 0.108% ITO nanoparticles, as shown in Table 1. Magnesium bis(2-ethylhexanoate) was used as the ACA for all samples except Sample 5, which contained magnesium salicylate.

For Sample 5 in Table 1 below, magnesium salicylate tetrahydrate was dissolved in water to prepare a 20 wt. % solution. 6.95 g was blended with each 1500 g PVB resin batch for extrusion as it could not be dissolved separately in the plasticizer, TEG-EG (triethylene glycol di-(2-ethylhexanoate)). The ACA calculation for magnesium salicylate tetrahydrate is as follows:

Grams 20% Magnesium Salicylate Tetrahydrate per 1500 g PVB=25*0.0000001*1500*370.6/(20/100) for 25 titer Mg=6.95 g.

For Samples 2, 3, and 4, and also for the Sample 1 and 6 standards, magnesium bis(2-ethylhexanoate) was used as a 40 wt. % aqueous solution and added at an amount equivalent to 20 titer for Sample 2 and 30 titer for Samples 3 and 4 to the respective plasticizer mixes and heated to 60° C. to drive off residual water and dissolve other additives, e.g., UV blocker and antioxidant. The ACA calculation for magnesium bis(2-ethylhexanoate) is as follows:

Grams 40% Magnesium bis(2-ethylhexanoate) per 1500 g PVB=20*0.0000001*1500*310/(40/100) for 20 titer Mg=2.325 g.

The Sample 5 plasticizer mix for use with the extrusion with magnesium salicylate only contained the plasticizer, TEG-EH, and the UV blocker and antioxidant. Similarly, they were heated to 60° C. to dissolve the solids into the plasticizer. The resultant extruded PVB sheet had 38 phr plasticizer content and 0.108% ITO (no ITO for Samples 1, 2 and 6). Results are shown in Table 1 below.

TABLE 1

| | | | | | | Potassium | Potassium | | | |
|---|---|---|---|---|---|---|---|---|---|---|
| | | Magnesium | Magnesium | Magnesium bis(2- | Total | acetate | acetate | | | |
| Sample | | salicylate | formate | ethylhexanoate) | Alkalinity | level* | (free) | Total Mg | Free Mg | % |
| No. | % ITO | (titer) | (titer) | (titer) | (titer) | (titer) | (titer) | (titer) | (titer) | Binding |
| 1 | 0.000 | 0 | 0 | 12 | 38.83 | 14.12 | 14.41 | 12.35 | 12.21 | 1.20 |
| 2 | 0.000 | 0 | 0 | 20 | 39.40 | −0.66 | −0.10 | 20.03 | 19.75 | 1.41 |
| 3 | 0.108 | 0 | 0 | 30 | 56.73 | −0.68 | 8.39 | 28.71 | 24.17 | 15.81 |
| 4 | 0.108 | 0 | 0 | 30 | 55.80 | −0.28 | 8.19 | 28.04 | 23.81 | 15.11 |
| 5 | 0.108 | 25 | 0 | 0 | 53.01 | 3.78 | 4.38 | 24.62 | 24.32 | 1.22 |
| 6 | 0.000 | 0 | 0 | 12 | 39.27 | 14.37 | 14.85 | 12.45 | 12.21 | 1.94 |
| 7 | 0.160 | 0 | 27 | 0 | 74.91 | 18.21 | 21.78 | 28.35 | 26.57 | 6.30 |
| 8 | 0.228 | 0 | 30 | 0 | 84.72 | 24.51 | 28.28 | 30.10 | 28.22 | 6.25 |

*based on total magnesium calculation of potassium acetate

The measurement standard statistics for the titration procedures are shown below.

| Measurement standard | Total | | |
|---|---|---|---|
| statistics** | Alkalinity | Total Mg | Free Mg |
| Average | 38.25 | 12.54 | 11.90 |
| Standard Deviation | 2.05 | 0.95 | 1.00 |
| Lower Limit | 32.10 | 9.69 | 8.92 |
| Upper Limit | 44.39 | 15.39 | 14.89 |

**Samples 1 and 6 are both measurement standards tested at the beginning and end of a sample titration set. The Average, Standard Deviation, Lower and Upper Limits are the acceptable ranges for valid titrations, determined for the measurement standard.

Per the results of ACA titrations, the Sample 5 PVB sheet extruded with 25 titer magnesium salicylate and 0.108% ITO nanoparticles had insignificant % binding as compared to Samples 3 and 4 made with 30 titer magnesium bis(2-ethylhexanoate) and 0.108% ITO nanoparticles. Compared to the control samples that contained no ITO nanoparticles, the extruded control Sample 2 without ITO and 20 titer magnesium bis(2-ethylhexanoate) and the standards (Samples 1 and 6) with approximately 12 titer magnesium from the magnesium bis(2-ethylhexanoate) there is a comparable insignificant level of % binding (e.g. less than 2%). Samples 7 and 8 of PVB sheet with 27 and 30 titer of magnesium formate and 0.160 and 0.228% ITO respectively (the highest loadings of ITO) had a lower level of % binding (e.g. less than 7%) than Samples 3 and 4, which had greater than 15% binding and were made with 30 titer magnesium bis(2-ethylhexanoate) and 0.108% ITO nanoparticles.

Peel Test Measurement: The 90° peel adhesion to glass values provided herein were determined according to the following procedure. First, a 12-inch by 6.75-inch glass/PVB sheet/aluminum foil laminate was prepared using a nip roll or vacuum de-airing method and the resulting laminate was autoclaved under standard laminated glass production conditions including hold conditions of 143° C. at 185 psig for 20 minutes. Prior to assembly, the glass was washed according to standard methods and the PVB sheet was conditioned to standard moisture content of 0.43 weight percent. The PVB sheet used in the laminate had a thickness of 30 mils (0.762 mm). The glass used to form the laminates was 2.3-mm thick clear float glass, and the laminate was assembled with the air side of the glass oriented toward the PVB layer. The aluminum foil was treated to ensure a very high adhesion to the PVB sheet.

After being autoclaved as described above, the laminates were stored at ambient conditions for at least 16 hours prior to testing. Laminates were then prepared for the peel adhesion test by cutting each 12-inch by 6.75-inch glass laminate into four test specimens by first cutting the laminate into separate sections, each having dimensions of 3 inches by 6.75 inches, and then cutting two parallel lines with a spacing of four centimeters down the center of each specimen through the aluminum foil and PVB layers along the long side of the specimen. Both cuts extended along the entire length of each specimen. Thereafter, each specimen was turned over and the glass was scored and broken along its width at a location approximately 2.25 inches from the top. The specimen was then bent at a 90° angle along the glass score line.

The peel adhesion of each specimen was then tested using a universal testing machine (UTM), such as those manufactured by Instron or MTS Systems, outfitted with a mounting system designed to perform a 90° peel adhesion measurement. The peel adhesion specimen was held in a sliding mounting device such that the upper 2.25-inch by 3-inch section was held firmly within the grips and the lower 3-inch by 4.5-inch section was supported, without interfering with the 4 cm test strip area, and the sample was oriented so that a 90° angle was maintained throughout the peel test. The specimen was then peeled at a rate of 5 inches per minute (in/min). The average peel force required over a length of 3 inches was determined (N) and normalized over the width of the test strip (4 cm) to provide the 90° peel adhesion value.

Additional samples were produced with magnesium salicylate, magnesium formate and magnesium bis(2-ethylhexanoate) with and without ITO nanoparticles (as indicated in Table 2) to test the % binding as well as the adhesion properties (as measured by peel and pummel tests). The samples and results are described below. All samples were made with poly(vinyl butyral) resin (BUTVAR® resin from Eastman Chemical Company) and TEG-EH plasticizer. The resin and plasticizer were mixed to achieve 38 parts per 100 parts TEG-EH plasticizer.

For Samples 9 and 10 (magnesium salicylate without ITO), the plasticizer mixes for extrusion with magnesium salicylate only contained the plasticizer (TEG-EH), the UV blocker and antioxidant. Magnesium salicylate titers were added as indicated to the resin separately. The plasticizer mix was heated to 60° C. to dissolve the UV stabilizer and antioxidant solids into the plasticizer. No ITO nanoparticle dispersion was added to the plasticizer mixes. In addition to the magnesium salicylate titers added to the resin, some additional potassium acetate titer was added to the resin to achieve the total potassium acetate titers indicated in Table 2 below.

For Samples 11, 12, 13 and 14 (magnesium salicylate with ITO), the plasticizer mixes for extrusion with magnesium salicylate only contained the plasticizer (TEG-EH), the UV blocker and antioxidant. Magnesium salicylate titers were added as indicated to the resin separately. The plasticizer mix was heated to 60° C. to dissolve the UV stabilizer and antioxidant solids into the plasticizer. ITO nanoparticle dispersion was added to the plasticizer mixes to achieve final ITO nanoparticle concentrations of either 0.1025% or 0.1600% ITO (as shown in Table 2). In addition to the magnesium salicylate titers added to the resin, some additional potassium acetate titer was added to the resin to achieve the total potassium acetate titers indicated in Table 2.

For Samples 15 and 16 (magnesium bis(2-ethylhexanoate) with ITO), magnesium bis(2-ethylhexanoate) was used as a 40 wt. % aqueous solution and was added at an amount equivalent to 25 titer for Sample 15 and 26 titer for Sample 16. The respective plasticizer mixes were heated to 60° C. to drive off residual water and dissolve other additives, e.g., UV blocker and antioxidant solids, into the plasticizer. ITO nanoparticle dispersion was added to the respective plasticizer mixes for Samples 15 and 16 so that a final ITO nanoparticle concentration of 0.1025% and 0.1600% ITO, respectively, would be achieved in PVB sheets extruded from the respective combined resin and plasticizer mixes. Added potassium acetate titer from PVB resin and added salt was 26.9 and 28.9 titer, respectively.

For Samples 17 and 18 (magnesium bis(2-ethylhexanoate) without ITO), the resin and plasticizer with dissolved magnesium bis(2-ethylhexanoate), UV stabilizer and antioxidant were mixed. No ITO was added. Total potassium acetate from PVB resin and added salt measured to be 14.1 and 14.4 titer.

For Samples 19 and 20 (magnesium bis(2-ethylhexanoate) with CWO), magnesium bis(2-ethylhexanoate) was used as a 40 wt. % aqueous solution and added to the resin and plasticizer at an amount equivalent to 17 titer. The respective plasticizer mixes were heated to 60° C. to drive off residual water and dissolve other additives, e.g., UV blocker and antioxidant solids, into the plasticizer. CWO nanoparticle dispersion was added to the respective plasticizer mixes for Samples 19 and 20, so that a final CWO nanoparticle concentration of 0.065% and 0.041% CWO, respectively, would be achieved in PVB sheets extruded from the respective combined resin and plasticizer mixes. Added potassium acetate titer from PVB resin and added salt was 28.3 titer for both samples.

For Samples 21 and 22 (magnesium formate with ITO), magnesium formate was used as a 10.0 wt % aqueous solution and added to the resin and plasticizer at an amount equivalent to 27 and 30 titer respectively for the two different levels of ITO, 0.160% and 0.228%. The respective plasticizer mixes were heated to 60° C. to drive off residual water and dissolve other additives, e.g., UV blocker and antioxidant solids, into the plasticizer. ITO nanoparticle dispersion was added to the respective plasticizer mixes. PVB sheets were extruded from the respective combined resin and plasticizer mixes. Added potassium acetate titer from PVB resin and added salt was 29.0 and 32.0 titer, respectively, for Samples 21 and 22.

For Samples 23 and 24 (magnesium bis(2-ethylhexanoate) with ITO), magnesium bis(2-ethylhexanoate) was used as a 40 wt. % aqueous solution and added to the resin and plasticizer at an amount equivalent to 28 and 23 titer respectively for the ITO level of 0.1079%. A plasticizer mixture or blend of two different plasticizers (35% dipropylene glycol dibenzoate/65% 3GEH) was used. The respective plasticizer mixes were heated to 60° C. to drive off residual water and dissolve other additives, e.g., UV blocker and antioxidant solids, into the plasticizer. ITO nanoparticle dispersion was added to the respective plasticizer mixes. PVB sheets were extruded from the respective combined resin and plasticizer mixes. Added potassium acetate titer from PVB resin and added salt was 26.0 and 28.0 titer, respectively, for Samples 23 and 24.

TABLE 2

| | | | | | Magnesium | Magnesium | Magnesium bis(2- | Potassium | |
|---|---|---|---|---|---|---|---|---|---|
| Sample | | Peel, | | | salicylate | formate | ethylhexanoate) | acetate | % |
| No. | Pummel | N/cm | % ITO | % CWO | (titer) | (titer) | (titer) | (titer) | Binding |
| 9 | 2.00 | 29.3 | 0.0000 | 0.0000 | 25 | 0 | 0 | 25.9 | 3.77 |
| 10 | 2.50 | 30.1 | 0.0000 | 0.0000 | 26 | 0 | 0 | 17.8 | 2.95 |
| 11 | 1.75 | 30.1 | 0.1025 | 0.0000 | 27 | 0 | 0 | 27.9 | 4.89 |
| 12 | 4.50 | 38.2 | 0.1025 | 0.0000 | 27 | 0 | 0 | 17.8 | 1.85 |
| 13 | 2.50 | 29.0 | 0.1600 | 0.0000 | 29 | 0 | 0 | 29.9 | 5.60 |
| 14 | 6.50 | 46.9 | 0.1600 | 0.0000 | 29 | 0 | 0 | 17.8 | 3.46 |
| 15 | 4.50 | 40.9 | 0.1025 | 0.0000 | 0 | 0 | 25 | 26.9 | 42.28 |
| 16 | 4.25 | 39.1 | 0.1600 | 0.0000 | 0 | 0 | 26 | 28.9 | 45.59 |
| 17 | 7.00 | 37.4 | 0.0000 | 0.0000 | 0 | 0 | 12 | 14.1 | 1.20 |
| 18 | 7.00 | 37.4 | 0.0000 | 0.0000 | 0 | 0 | 12 | 14.4 | 1.94 |
| 19 | 6.25 | 38.7 | 0.0000 | 0.0650 | 0 | 0 | 17 | 28.3 | 13.76 |
| 20 | 3.75 | 34.9 | 0.0000 | 0.0410 | 0 | 0 | 17 | 28.3 | 8.46 |
| 21 | 3.50 | 34.5 | 0.1600 | 0.0000 | 0 | 27 | 0 | 29.0 | 6.30 |
| 22 | 3.25 | 36.1 | 0.2280 | 0.0000 | 0 | 30 | 0 | 32.0 | 6.25 |
| 23*** | 2.50 | 28.8 | 0.1079 | 0.0000 | 0 | 0 | 28 | 26.0 | 27.73 |
| 24*** | 5.50 | 33.1 | 0.1079 | 0.0000 | 0 | 0 | 23 | 28.0 | 18.34 |

***Samples 23 and 24 include a plasticizer mixture of 35% dipropylene glycol dibenzoate/65% 3GEH.

As shown by the results of ACA titrations of the as-extruded sheets in Table 2, Samples 15 and 16 as well as Samples 23 and 24 (magnesium bis(2-ethylhexanoate) with ITO) have significantly elevated % binding or hydrolysis as compared to samples without ITO or samples where magnesium salicylate or magnesium formate were used. The magnesium salicylate and magnesium formate ACAs of the present invention effectively resisted hydrolysis during extrusion in the presence of ITO and kept the % binding low (i.e., less than 25% binding or less than 20% binding or less than 15% binding).

The pKa of each of the carboxylic acids used to formulate each of the magnesium carboxylate salts is shown in Table 3.

TABLE 3

| Acid | pKa |
|---|---|
| 2EHA | 4.82 |
| Formic Acid | 3.77 |
| Salicylic Acid | 2.97 |

To reduce or prevent the percent binding or hydrolysis while maintaining an acceptable adhesion level, the inventor has found that using a different magnesium salt (having carboxylate groups wherein the pKa of the corresponding carboxylic acids is less than about 4.80) as the adhesion control agent instead of the conventional adhesion control agent, magnesium bis(2-ethylhexanoate) (which has carboxylate groups having corresponding carboxylic acids having a pKa of about 4.82) reduces the percent binding or hydrolysis of the magnesium salt ACA and produces acceptable adhesion levels.

As previously mentioned, the magnesium salt is a magnesium carboxylate salt comprising a magnesium salt that is a divalent magnesium with at least one carboxylate group, and is derived from the general formula: M(R′COO)ₙ wherein M is a metal, such as magnesium, and n is an integer, such as 1, 2, 3 or 4. The magnesium salt of the present invention specifically has the formula M(R′COO)ₙ where M is magnesium, n is 2 and R′ is an organic group having from 1 to 20 carbon atoms. The organic group may be, for example, an alkyl, an aryl or a heterocycle group. The magnesium salt also includes the corresponding hydrates. In embodiments, the pKa of the corresponding carboxylic acid is in a range of from about 2.00 to less than about 4.80. In embodiments, the pKa of the corresponding carboxylic acid is greater than 2.00, greater than 2.10, greater than 2.20, greater than 2.30, greater than 2.40, greater than 2.50, greater than 2.60, greater than 2.70, greater than 2.80, greater than 2.90, greater than 3.00, greater than 3.10, greater than 3.20, greater than 3.30, greater than 3.40, greater than 3.50, greater than 3.60, or greater than 3.70. In embodiments, the pKa of the corresponding carboxylic acid is less than 4.70, less than 4.60, less than 4.50, less than 4.40, less than 4.30, less than 4.20, less than 4.10, or less than 4.00.

The magnesium carboxylate salts of the invention are generally synthesized from the reaction of magnesium hydroxide (or oxide) and an acid that is stronger than 2-ethylhexanoic acid (“2-EHA”), the acid that is used to produce one of the standard or commonly used adhesion control salts (RSS5). Other known adhesion control salts or adhesion control agents (“ACAs”), include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

By using an acid that is stronger than 2-EHA, the result is a less basic (reactive) magnesium salt. The general reaction may be as follows:

Mg(OH)₂+2(R′COOH)→Mg(ROO)₂+2 H2O, where R′ is an organic group having from 1 to 20 carbon atoms, such as an alkyl, aryl or heterocycle group.

1. A polymer composition comprising:
a. poly(vinyl acetal) resin;
b. a solar additive;
c. sodium and/or potassium acetate;
d. at least one plasticizer; and
e. a magnesium salt comprising a divalent magnesium ion and at least 2 carboxylate groups wherein the corresponding carboxylic acids of the carboxylate groups each have a pKa of less than about 4.80, wherein the titer of magnesium salt or hydrate thereof is from about 10 to about 60, wherein the alkalinity titer attributable to the combination of potassium and sodium acetate is from about 10 to about 60, and wherein the ratio of the titer of magnesium salt or hydrate thereof to the alkalinity titer attributable to the combination of potassium and sodium acetate is about 0.5 to about 2.0.

2. The composition of claim 1, wherein the plasticizer comprises a high refractive index plasticizer having a refractive index of at least 1.460, measured by ASTM D542 at a wavelength of 589 nm and a temperature of 25° C.

3. The composition of claim 1, wherein the solar additive is indium tin oxide, antimony tin oxide or a metal-doped tungsten oxide.

4. The composition of claim 3, wherein the metal-doped tungsten oxide is cesium-doped tungsten oxide or cesium and tin doped tungsten oxide.

5. The composition of claim 1, further comprising rutile titanium dioxide.

6. The composition of claim 1, wherein the magnesium salt or hydrate thereof titer is from about 10 to about 40.

7. The composition of claim 1, wherein the alkalinity titer is from about 10 to about 40.

8. The composition of claim 1, further comprising one or more epoxy compounds.

9. The composition of claim 8, wherein the epoxy compound is selected from diepoxides of polyglycols, aliphatic cyclic mono-epoxides and aliphatic cyclic diepoxides.

10. The composition of claim 9, wherein the epoxy compound is chosen from 3,4-epoxycyclohexylmethyl-3,4-epoxycyclohexane; bis (3,4-epoxy-6-methylcyclohexylmethyl adipate); 2-(3,4-epoxycyclohexyl)-5,5-spiro(3,4-epoxy)cyclohexane-m-dioxane; 2-ethylhexyl glycidyl ether; diepoxides of poly(oxypropylene) glycol, and diepoxide counterparts of epichlorohydrin and polypropylene glycol.

11. The composition of claim 1, further comprising one or more silane additive or silane-containing compounds.

12. The composition of claim 11, wherein the silane-containing compound is chosen from γ-glycidoxypropyltrimethoxysilane, aminopropyltriethoxysilane, aminoethylaminopropyltrimethoxysilane, and combinations thereof.

13. The composition of claim 1, wherein the magnesium salt is magnesium salicylate, magnesium formate, magnesium salicylate tetrahydrate or magnesium formate dihydrate.

14. The composition of claim 1, wherein the poly(vinyl acetal) resin has a moisture level of less than about 1 wt. %.

15. The composition of claim 1, wherein the % binding is less than about 15%.

16. A polymer composition comprising:
a. poly(vinyl acetal) resin having a moisture level of less than about 1 wt. %;
b. a solar additive;
c. sodium and/or potassium acetate;
d. at least one plasticizer; and
e. magnesium salt comprising a divalent magnesium ion and at least 2 carboxylate groups wherein the corresponding carboxylic acids of the carboxylate groups each have a pKa of less than about 4.80, wherein the titer of magnesium salt or hydrate thereof is from about 10 to about 60, wherein the alkalinity titer attributable to the combination of potassium and sodium acetate is from about 10 to about 60, and wherein the ratio of the titer of magnesium salt or hydrate thereof to the alkalinity titer attributable to the combination of potassium and sodium acetate is about 0.5 to about 2.0,
wherein the level of binding is less than about 25%.

17. An interlayer sheet comprising the composition of claim 16, wherein the composition is formed into the interlayer sheet.

18. The interlayer sheet of claim 17, further comprising one or more additional layers to form a multi-layer sheet.

19. The interlayer sheet of claim 18, wherein the interlayer sheet comprises three layers.

20. A laminated safety glass comprising two sheets of glass and the interlayer sheet of claim 19, wherein the interlayer sheet is disposed between the two glass sheets.
